(19) United States
(12) Patent Application Publication
(10) Pub. No.: US 2015/0256967 A1
(43) Pub. Date: Sep. 10, 2015

(54) ENTRY CHECKING SYSTEM, METHOD FOR THE SAME, AND APPARATUS APPLIED TO THE SAME

(71) Applicant: SK PLANET CO., LTD., GYEONGGI-DO (KR)

(72) Inventors: CHUL YONG SHIN, SEOUL (KR); JAE HYUNG HUH, GYEONGGI-DO (KR)

(73) Assignee: SK PLANET CO., LTD., GYEONGGI-DO (KR)

(21) Appl. No.: 14/639,316

(22) Filed: Mar. 5, 2015

(30) Foreign Application Priority Data
Mar. 7, 2014 (KR) 10-2014-0027136

(51) Int. Cl. H04W 4/00; H04L 29/12; G06Q 30/02; H04W 8/20; H04W 60/04

(52) U.S. Cl. CPC H04W 4/008; H04W 8/20; H04W 60/04; G06Q 30/0281; H04L 61/1541

(57) ABSTRACT

The present invention discloses an entry checking system, a method for the same, and an apparatus applied to the same. That is, the present invention may form an exclusive coverage based on an IP in a beacon apparatus based on Bluetooth to enable a user terminal to access based on the IP rather than the Bluetooth, transmit unique identification information received from the accessed user terminal to a checking server based on the IP, and enable the checking server to check an entry of the user terminal into the exclusive coverage regardless of whether the Bluetooth is supported by the user terminal or whether the user terminal accesses through a wireless Internet based on the IP.

### BACKGROUND OF THE INVENTION

1. Field of the Invention

The present invention relates to a method of forming an exclusive coverage based on an IP in a beacon apparatus based on Bluetooth, enabling a user terminal to access to the exclusive coverage based on the IP rather than the Bluetooth, and transmitting unique identification information received from the accessed user terminal to a checking server, based on the IP.

2. Description of the Prior Art

In general, a method of using payment-based transaction data or a method of transmitting data recognizing a beacon apparatus in a shop by a user terminal may be applied to a method of checking a history of a visitor in an offline shop.

Here, in the above-mentioned case wherein the user terminal recognizes the beacon apparatus, the user terminal recognizes a beacon signal transmitted from the beacon apparatus installed in the shop, and the user terminal transmits the beacon signal, as visit information, to a server through the Internet.

However, in order to transmit the visit information from the user terminal to the server, the Internet access by the user terminal should be possible, and when the Internet access is impossible, a normal service may be not provided.

### SUMMARY OF THE INVENTION

The present invention is made by considering the above-mentioned problems, an aspect of the present invention is to form an exclusive coverage based on an IP in a beacon apparatus based on Bluetooth to enable a user terminal to access based on the IP rather than the Bluetooth, transmit unique identification information received from the accessed user terminal to a checking server based on the IP, and enable the checking server to check an entry of the user terminal into the exclusive coverage regardless of whether the Bluetooth is supported by the user terminal or whether the user terminal accesses through a wireless Internet based on the IP.

A beacon apparatus based on Bluetooth according to a first aspect of the present invention for solving the above-mentioned problems includes: a forming unit configured to form an exclusive coverage based on an IP and enable the user terminal which recognizes the exclusive coverage to access based on the IP rather than the Bluetooth, the exclusive coverage being for checking only an entry of the user terminal; and a processing unit configured to acquire unique identification information from the accessed user terminal when the user terminal is accessed, transmit the acquired unique identification information to a checking server based on the IP, and enable the checking server to check the entry of the user terminal into the exclusive coverage regardless of whether the Bluetooth is supported by the user terminal.

More specifically, the forming unit transmits a Service Set IDentifier (SSID) based on the IP to form the exclusive coverage, and the user terminal includes an application related to the access to the beacon apparatus and transfers the unique identification information to the beacon apparatus through the application, when the SSID transmitted from the forming unit is identified.

More specifically, a wireless Internet access based on the IP is impossible or the wireless Internet access based on the IP is limited to the user terminal which accesses the beacon apparatus, in the exclusive coverage.

An entry checking method according to a second aspect of the present invention for solving the above-mentioned problems includes: forming an exclusive coverage based on an IP by a beacon apparatus based on Bluetooth, the exclusive coverage being for checking only an entry of a user terminal; recognizing the exclusive coverage and accessing the beacon apparatus by the user terminal, based on the IP rather than the Bluetooth; acquiring unique identification information from the accessed user terminal by the beacon apparatus; and transmitting the acquired unique identification information from the beacon apparatus to a checking server so as to enable the checking server to check the entry of the user terminal into the exclusive coverage regardless of whether the Bluetooth is supported by the user terminal.

An operation method according to a third aspect of the present invention for solving the above-mentioned problems includes: forming an exclusive coverage based on an IP and enabling the user terminal which recognizes the exclusive coverage to access based on the IP rather than the Bluetooth, the exclusive coverage being for checking only an entry of the user terminal; acquiring unique identification information from the accessed user terminal when the user terminal is accessed; and transmitting the acquired unique identification information to a checking server so as to enable the checking server to check the entry of the user terminal into the exclusive coverage regardless of whether the Bluetooth is supported by the user terminal.

More specifically, the forming includes transmitting a Service Set IDentifier (SSID) based on the IP to form the exclusive coverage, and the user terminal includes an application related to the access to the beacon apparatus and transfers the unique identification information to the beacon apparatus through the application, when the SSID is identified transmitted in the forming.

More specifically, a wireless Internet access based on the IP is impossible or the wireless Internet access based on the IP is limited to the user terminal which accesses the beacon apparatus, in the exclusive coverage.

Therefore, the entry checking system, the method for the same, and the apparatus applied to the same may form an exclusive coverage based on an IP in a beacon apparatus based on Bluetooth to enable a user terminal to access based on the IP rather than the Bluetooth, transmit unique identification information received from the accessed user terminal to a checking server based on the IP, and enable the checking server to check an entry of the user terminal into the exclusive coverage regardless of whether the Bluetooth is supported by the user terminal or whether the user terminal accesses through a wireless Internet based on the IP.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic configuration view of an entry checking system according to an embodiment of the present invention;

FIG. 2 is a schematic configuration view of a beacon apparatus according to an embodiment of the present invention;

FIG. 3 is a schematic flowchart for describing an operation flow in the entry checking system according to an embodiment of the present invention; and

FIG. 4 is a schematic flowchart, for describing an operation flow in the beacon apparatus according to an embodiment of the present invention.

### DETAILED DESCRIPTION OF THE EXEMPLARY EMBODIMENTS

Hereinafter, an embodiment of the present invention will be described with reference to the accompanying drawings.

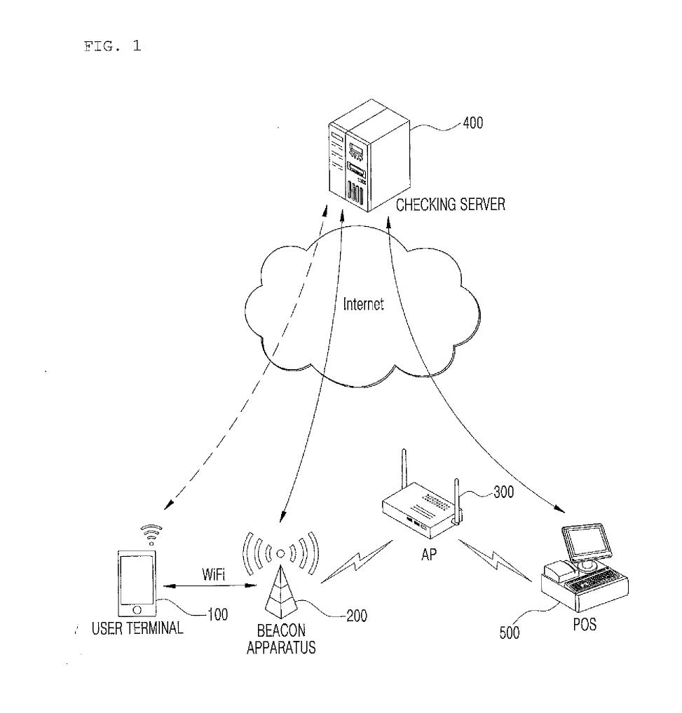

FIG. 1 is a view illustrating an entry checking system according to an embodiment of the present invention.

As shown in FIG. 1, the entry checking system according to an embodiment of the present invention includes a user terminal 100, a beacon apparatus 200 configured to form an exclusive coverage based on an IP, and a checking server 400 configured to check the entry of the user terminal into the exclusive coverage. Here, the exclusive coverage is for checking an entry of the user terminal.

In addition, the entry checking system according to an embodiment of the present invention may further include an AP 300 enabling a wireless Internet access based on the IP, and a POS 500 configured to receive additional information related to the user terminal 100 from the checking server 300, in addition to the above-mentioned components.

The user terminal 100 is referred to as a mobile device which can access the beacon apparatus 200 when the user terminal 100 enters to the exclusive coverage.

For example, the user terminal 100 may be a smart phone, a tablet PC, a PDA, and the like, but is not limited thereto. That is, the user terminal 100 may include all devices enabling a network access based on the IP and additionally supporting Bluetooth.

Here, the user terminal 100 may include an application related to an entry checking service, and may transmit information related to the entry into the exclusive coverage to the beacon apparatus 200 through the application.

For example, the beacon apparatus 200 may be referred to as a device disposed in the offline shop and capable of performing a data communication with the user terminal 100, based on the Bluetooth.

The beacon apparatus 200 according to an embodiment of the present invention may access the user terminal 100, based on the IP (e.g., WiFi) in addition to the above-mentioned Bluetooth.

Here, a standard of the Bluetooth adapted by the beacon apparatus 200 may be a Bluetooth Low Energy (BLE) scheme which is a low energy scheme in the Bluetooth v4.0.

In addition, the beacon apparatus 200 forms the exclusive coverage in a shop in order to check the entry of the user terminal 100 into the shop. The exclusive coverage is formed based on the IP rather than the Bluetooth.

For example, the exclusive coverage formed as described above may be a WiFi coverage.

However, in the exclusive coverage, all wireless Internet accesses based on the IP are prohibited, or a wireless Internet access is limited to only the user terminal 100 which accesses the beacon apparatus 200. This is because a purpose of the user terminal 100 is being a means to be checked when the user terminal 100 enters the shop, rather than being a means for a use of the wireless Internet.

The checking server 300 is referred to as a database server configured to extract additional information stored in relation to the user terminal 100 and transmit the extracted additional information to the POS 500 in the shop, when the checking server checks the entry of the user terminal 100 into the exclusive coverage.

Here, for example, the additional information may include a purchase history, an item of interest, a visit history, and the like, but is not limited thereto. That is, the additional information may include various information related to a user having the user terminal 100.

Meanwhile, according to an embodiment of the present invention, an entry checking service is provided so as to provide related additional information by checking the entry of the user terminal 100 into the shop when the user terminal 100 enters the shop.

In the case of such an entry checking service, a scheme wherein the user terminal 100 transmits data which indicates recognizing the beacon apparatus 200 installed in the shop may be applied.

In this case, the beacon apparatus 200 transmits a beacon signal including apparatus identification information, based on the Bluetooth. The user terminal 100 transmits the apparatus identification information received through the Internet to the checking server 400 as the visit information, and thus the checking server 400 may check that the user terminal 100 enters the shop where the beacon apparatus 200 is installed.

However, in such a scheme, in order to transmit the visit information from the user terminal 100 to the checking server 400, it should be required that the user terminal 100 may access through the wireless Internet access.

Especially, when the user terminal 100 does not support the Bluetooth, the user terminal 100 cannot receive the beacon signal transmitted from the beacon apparatus 200.

As described above, in checking the entry of the user terminal 100 into the shop, it is determined whether the service is provided or not according to whether the wireless Internet access and the Bluetooth are supported or not. Therefore, a new method, which enables a normal service even though the wireless Internet access and the Bluetooth are not supported, is required.

Thus, an embodiment of the present invention proposes a method, which enables a normal entry checking service even though the wireless Internet access and the Bluetooth are not supported by the user terminal 100, and hereinafter, the method will be described in more detail.

Firstly, the beacon apparatus 200 performs a function of forming the exclusive coverage.

More specifically, the beacon apparatus 200 transmits an apparatus identifier to a near field area, and forms the exclusive coverage up to a boundary of an area where the transmitted apparatus identifier can be sensed such that the user terminal 100 having entered the exclusive coverage identifies the apparatus identifier and accesses the beacon apparatus 200.

Here, for example, the apparatus identifier transmitted from the beacon apparatus 200 may be a Service Set IDentifier (SSID).

In addition, the user terminal 100 performs a function of identifying the apparatus identifier.

More specifically, the user terminal 100 performs a continuous scanning operation in a state wherein a near field wireless network function (e.g., WiFi) is activated (i.e., turned on), and therefore, the user terminal 100 may identify the apparatus identifier transmitted from the beacon apparatus 200 when the user terminal 100 enters the exclusive coverage formed by the beacon apparatus 200.

In addition, the beacon apparatus 200 performs a function of accessing the user terminal 100.

More specifically, the beacon apparatus 200 is connected to the user terminal through networking based on a series of IPs such that the user terminal 100 having entered the exclusive coverage accesses the beacon apparatus 200.

Here, the networking based on the IP is identical to a usual WiFi access process, and therefore a detailed description related to the networking based on the IP will be omitted.

In the same manner, the user terminal 100 performs a function of accessing the beacon apparatus 200.

More specifically, when the user terminal 100 identifies the apparatus identifier transmitted from the beacon apparatus 200 according to the entry into the exclusive coverage, in the same manner as above, the user terminal 100 is connected to the beacon apparatus 200 through networking based on the IP, and therefore the user terminal 100 may access the beacon apparatus 200.

In addition, the beacon apparatus 200 performs a function of acquiring a unique identifier of the user terminal 100.

More specifically, when the access of the user terminal 100 is completed, the beacon apparatus 200 receives the unique identifier from the accessed user terminal 100.

Here, for example, the unique identifier acquired from the user terminal 100 may include an International Mobile Subscriber Identity (IMSI), International Mobile Equipment Identity (IMEI), a terminal number (e.g., MIN and MDN), and the like, but it is not limited thereto. That is, the unique identifier may include all information which can identify the user terminal 100.

In addition, the user terminal 100 performs a function of transmitting the unique identifier.

More specifically, when the user terminal 100 accesses to the beacon apparatus, the user terminal 100 drives an application, which has already been installed in the user terminal 100, in relation to the entry checking service, and thus the user terminal 100 transmits the unique identifier thereof to the beacon apparatus 200 through the application.

In addition, the beacon apparatus 200 performs a function of transferring the acquired unique identifier.

More specifically, when the beacon apparatus 200 acquires the unique identification information from the user terminal 100, the beacon apparatus 200 transmits the acquired unique identification information to the checking server 400 based on the IP. Therefore, the beacon apparatus 200 enables the checking server 400 to check the entry of the user terminal 100 into the shop corresponding to the exclusive coverage, extract the additional information stored in relation to the user terminal 100, and provide the additional information to the POS 500 in the shop.

At this time, the beacon apparatus 200 transfers the unique identification information acquired from the user terminal 100 to an AP 300 which may access through the wireless Internet, in order to enable the AP 300 to transmit the transferred unique identification information to the checking server 400 through the wireless Internet.

As described above, after the beacon apparatus 200 accesses the user terminal 100 having entered the shop, based on the IP, the beacon apparatus 200 receives the unique identification information and transmits the unique identification information to the checking server 400. Therefore, a normal entry checking service can be provided, even though the user terminal 100 does not access through the wireless Internet and the Bluetooth is not supported by the user terminal 100.

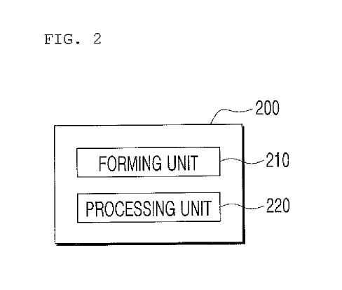

Hereinafter, a configuration of the beacon apparatus 200 according to an embodiment of the present invention will be described in more detail with reference to FIG. 2.

That is, the beacon apparatus 200 according to an embodiment of the present invention includes a forming unit 210 and a processing unit 220. The forming unit 210 forms the exclusive coverage and enables the user terminal 100 to access the beacon apparatus 200. The processing unit 220 acquires the unique identification information from the accessed user terminal 100 and transmits the unique identification information to the checking server 400.

Here, a whole or at least a part of the beacon apparatus 200 including the above-mentioned forming unit 210 and the processing unit 220 may be implemented as a software module form executed by a processor, or may be implemented as a combination of a software module and a hardware.

Firstly, the forming unit 210 performs the function of forming the exclusive coverage.

More specifically, the forming unit 210 transmits the apparatus identifier to the near field area, and forms the exclusive coverage up to the boundary of the area where the transmitted apparatus identifier can be sensed such that the user terminal 100 having entered the exclusive coverage identifies the apparatus identifier and accesses the beacon apparatus 200.

At this time, the user terminal 100 performs the continuous scanning operation in the state wherein the near field wireless network function (e.g., WiFi) is activated (i.e., turned on), and therefore, the user terminal 100 may identify the apparatus identifier transmitted from the beacon apparatus 200 when the user terminal 100 enters the exclusive coverage.

In addition, the forming unit 210 performs the function of accessing the user terminal 100.

More specifically, the forming unit 210 is connected to the user terminal 100 through networking based on a series of IPs such that the user terminal 100 having entered the exclusive coverage accesses the beacon apparatus 200.

At this time, when the user terminal 100 identifies the apparatus identifier transmitted from the beacon apparatus 200 according to the entry into the exclusive coverage, in the same manner as above, the user terminal 100 is connected to the beacon apparatus 200 through the networking based on the IP, and therefore the user terminal 100 may access the beacon apparatus 200.

In addition, the processing unit 220 performs the function of acquiring the unique identifier of the user terminal 100.

More specifically, when the access of the user terminal 100 is completed, the processing unit 220 receives the unique identifier from the accessed user terminal 100.

At this time, when the user terminal 100 accesses the beacon apparatus 200, the user terminal 100 drives the application, which has already been installed in the user terminal 100, in relation to the entry checking service, and thus the user terminal 100 transmits the unique identifier thereof to the beacon apparatus 200 through the application.

In addition, the processing unit 220 performs the function of transferring the acquired the unique identifier.

More specifically, when the processing unit 220 acquires the unique identification information from the user terminal 100, the processing unit 220 transmits the acquired unique identification information to the checking server 400 based on the IP. Therefore, the processing unit 220 enables the checking server 400 to check the entry of the user terminal 100 into the shop corresponding to the exclusive coverage, extract the additional information stored in relation to the user terminal 100, and provide the additional information to the POS 500 in the shop.

At this time, the processing unit 220 transfers the unique identification information acquired from the user terminal 100 to the AP 300 which may access through the wireless Internet, in order to enable the AP 300 to transmit the transferred unique identification information to the checking server 400 through the wireless Internet.

As described above, according to the entry checking system according to an embodiment of the present invention, the beacon apparatus 200 based on the Bluetooth forms the exclusive coverage based on the IP such that the user terminal 100 accesses based on the IP rather than the Bluetooth, and transmits the unique identification information received from the accessed user terminal to the checking server based on the IP. Therefore, the checking server 400 can check the entry of the user terminal 100 into the exclusive coverage regardless of whether the Bluetooth is supported by the user terminal 100 and whether the user terminal 100 accesses through the wireless Internet based on the IP.

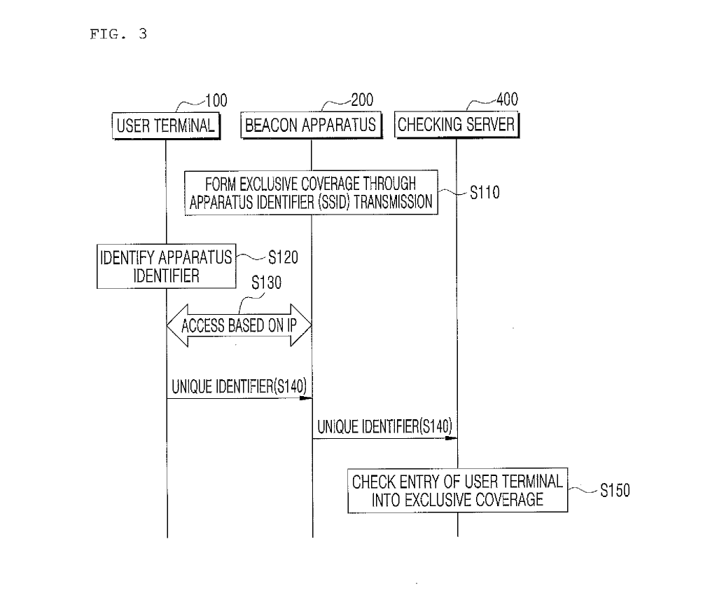

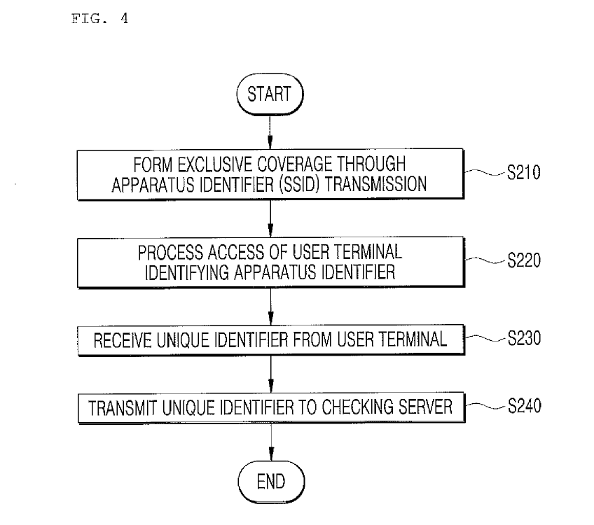

Hereinafter, an entry checking method according to an embodiment of the present invention will be described with reference to FIGS. 3 and 4. Here, for convenience of description, configurations shown in FIGS. 1 and 2 will be described using the corresponding reference numerals.

Firstly, an operation flow of the entry checking system according to an embodiment of the present invention will be described with reference to FIG. 3.

Firstly, the beacon apparatus 200 transmits the apparatus identifier to the near field area, and forms the exclusive coverage up to the boundary of the area where the transmitted apparatus identifier can be sensed such that the user terminal 100 having entered the exclusive coverage identifies the apparatus identifier and accesses the beacon apparatus 200 (S110).

Then, the user terminal 100 performs the continuous scanning operation in the state wherein the near field wireless network function (e.g., WiFi) is activated (i.e., turned on), and therefore the user terminal 100 identifies the apparatus identifier transmitted from the beacon apparatus 200 when the user terminal 100 enters the exclusive coverage (S120).

Next, the beacon apparatus 200 is connected to the user terminal 100 through networking based on a series of IPs such that the user terminal 100 having entered the exclusive coverage accesses the beacon apparatus 200 (S130).

Next, when the user terminal 100 accesses the beacon apparatus 200, the user terminal 100 drives the application, which has already been installed in the user terminal 100, in relation to the entry checking service, and thus the user terminal 100 transmits the unique identifier thereof to the beacon apparatus 200 through the application (S140).

Next, when the beacon apparatus 200 receives the unique identification information from the user terminal 100, the beacon apparatus 200 transmits the acquired unique identification information to the checking server 400 based on the IP. Therefore, the beacon apparatus 200 enables the checking server 400 to check the entry of the user terminal 100 into the shop corresponding to the exclusive coverage, extract the additional information stored in relation to the user terminal 100, and provide the additional information to the POS 500 in the shop (S50).

this time, the beacon apparatus 200 transfers the unique identification information acquired from the user terminal 100 to the AP 300 which may access through the wireless Internet, in order to enable the AP 300 to transmit the transferred unique identification information to the checking server 400 through the wireless Internet.

Hereinafter an operation of the beacon apparatus 200 according to an embodiment of the present invention will be described in more detail with reference to FIG. 4.

Firstly, the forming unit 210 transmits the apparatus identifier to the near field area, and forms the exclusive coverage up to the boundary of the area where the transmitted apparatus identifier can be sensed such that the user terminal 100 having entered the exclusive coverage identifies the apparatus identifier and accesses the beacon apparatus 200 (S210).

At this time, the user terminal 100 performs the continuous scanning operation in the state wherein the near field wireless network function (e.g., WiFi) is activated (i.e., turned on), and therefore, the user terminal 100 may identify the apparatus identifier transmitted from the beacon apparatus 200 when the user terminal 100 enters the exclusive coverage.

Then, the forming unit 210 is connected to the user terminal 100 through networking based on a series of IPs such that the user terminal 100 having entered the exclusive coverage accesses the beacon apparatus 200 (S220).

At this time, when the user terminal 100 identifies the apparatus identifier of the beacon apparatus 200 according to the entry into the exclusive coverage, in the same manner as above, the user terminal 100 is connected to the beacon apparatus 200 through the networking based on the IP, and therefore the user terminal 100 may access the beacon apparatus 200.

Then, when the access of the user terminal 100 is completed, the processing unit 220 receives the unique identifier from the accessed user terminal 100 (S230).

At this time, when the user terminal 100 accesses the beacon apparatus 200, the user terminal 100 drives the application, which has already been installed in the user terminal 100, in relation to the entry checking service, and thus the user terminal 100 transmits the unique identifier thereof to the beacon apparatus 200 through the application.

Next, when the processing unit 220 receives the unique identification information from the user terminal 100, the processing unit 220 transmits the acquired unique identification information to the checking server 400 based on the IP Therefore, the processing unit 220 enables the checking server 400 to check the entry of the user terminal 100 into the shop corresponding to the exclusive coverage, extract the additional information stored in relation to the user terminal 100, and provide the additional information to the POS 500 in the shop.

At this time, the processing unit 220 transfers the unique identification information acquired from the user terminal 100 to the AP 300 which may access through the wireless Internet, in order to enable the AP 300 to transmit the transferred unique identification information to the checking server 400 through the wireless Internet.

As described above, according to the entry checking method according to an embodiment of the present invention, the beacon apparatus 200 based on the Bluetooth forms the exclusive coverage based on the IP such that the user terminal 100 accesses based on the IP rather than the Bluetooth, and transmits the unique identification information received from the accessed user terminal to the checking server based on the IP. Therefore, the checking server 400 can check the entry of the user terminal 100 into the exclusive coverage regardless of whether the Bluetooth is supported by the user terminal 100 and whether the user terminal 100 accesses through the wireless Internet based on the IP.

Meanwhile, functional operations and subject matters described in the specification may be implemented using a digital electronic circuit, a structure disclosed in the specification, a computer software, a firmware or a hardware including the equivalent of the structure, or a combination of at least one among them. The subject matters described in the specification may be implemented as at least one computer program product. That is, the subject matters may be implemented as at least one module related to a computer program instruction encoded on a physical program recording medium in order to control or execute an operation of a process system.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present invention. Therefore, while the present invention was described in detail with reference to the above-mentioned examples, a person skilled in the art may modify, change and transform some parts without departing a scope of the present invention.

According to the entry checking system, the method for the same, and the apparatus applied to the same of the present invention, the beacon apparatus based on the Bluetooth forms the exclusive coverage based on the IP such that the user terminal accesses the exclusive coverage based on the IP rather than the Bluetooth, and transmits the unique identification information received from the accessed user terminal to the checking server based on the IP. Therefore, since the present invention overcomes a limitation according to the prior art, it is possible to use the relevant art, and sell, promote and practically and apparently implement the apparatus employing the relevant art, and thus the present invention has an industrial applicability.

### DESCRIPTION OF REFERENCE NUMERALS

100: User terminal

200: Beacon apparatus

210: Forming unit

220: Processing unit

300: AP

400: Checking server

500: POS

What is claimed is:

1. A beacon apparatus based on Bluetooth, comprising:
a forming unit configured to form an exclusive coverage based on an IP and enable a user terminal which recognizes the exclusive coverage to access based on the IP rather than the Bluetooth, the exclusive coverage being for checking an entry of the user terminal; and
a processing unit configured to acquire unique identification information from the accessed user terminal when the user terminal is accessed, transmit the acquired unique identification information to a checking server based on the IP, so as to enable the checking server to check the entry of the user terminal into the exclusive coverage regardless of whether the Bluetooth is supported by the user terminal.

2. The beacon apparatus of claim 1, wherein the forming unit transmits a Service Set IDentifier (SSID) based on the IP to form the exclusive coverage, and
the user terminal includes an application related to the access to the beacon apparatus, and transfers the unique identification information to the beacon apparatus through the application, when the SSID transmitted from the forming unit is identified.

3. The beacon apparatus of claim 1, wherein a wireless Internet access based on the IP is impossible or the wireless Internet access based on the IP is limited to the user terminal which accesses the beacon apparatus, in the exclusive coverage.

4. An entry checking method comprising:
forming an exclusive coverage based on an IP by a beacon apparatus based on Bluetooth, the exclusive coverage being for checking an entry of a user terminal;
recognizing the exclusive coverage and accessing the beacon apparatus by the user terminal, based on the IP rather than the Bluetooth;
acquiring unique identification information from the accessed user terminal by the beacon apparatus; and
transmitting the acquired unique identification information from the beacon apparatus to a checking server so as to enable the checking server to check the entry of the user terminal into the exclusive coverage regardless of whether the Bluetooth is supported by the user terminal.

5. An operation method of a beacon apparatus based on Bluetooth, the method comprising:
forming an exclusive coverage based on an IP and enabling a user terminal which recognizes the exclusive coverage to access based on the IP rather than the Bluetooth, the exclusive coverage being for checking an entry of the user terminal;
acquiring unique identification information from the accessed user terminal when the user terminal is accessed; and
transmitting the acquired unique identification information to a checking server so as to enable the checking server to check the entry of the user terminal into the exclusive coverage regardless of whether the Bluetooth is supported by the user terminal.

6. The method of claim 5, wherein the forming includes transmitting a Service Set IDentifier (SSID) based on the IP to form the exclusive coverage, and
the user terminal includes an application related to the access to the beacon apparatus, and transfers the unique identification information to the beacon apparatus through the application, when the SSID is identified transmitted in the forming.

7. The method of claim 5, wherein a wireless Internet access based on the IP is impossible or the wireless Internet access based on the IP is limited to the user terminal which accesses the beacon apparatus, in the exclusive coverage.
